(19) United States
(12) Patent Application Publication
(10) Pub. No.: US 2021/0261424 A1
(43) Pub. Date: Aug. 26, 2021

(54) METHOD FOR AVOIDING VOC AND HAP EMISSIONS FROM SYNTHESIS GAS-PROCESSING SYSTEMS

(71) Applicants: thyssenkrupp Industrial Solutions AG, Essen (DE); thyssenkrupp AG, Essen (DE)

(72) Inventors: Bernd Mielke, Bochum (DE); Klaus Nölker, Dortmund (DE)

(73) Assignees: thyssenkrupp Industrial Solutions AG, Essen (DE); thyssenkrupp AG, Essen (DE)

(21) Appl. No.: 17/255,268

(22) PCT Filed: Jun. 24, 2019
(86) PCT No.: PCT/EP2019/066573

§ 371 Date: Dec. 22, 2020

(30) Foreign Application Priority Data
Jul. 3, 2018 (DE) 10 2018 210 910.9

(51) Int. Cl. C01C 1/04; B01D 53/14; C01B 3/02; C01B 3/58

(52) U.S. Cl. CPC C01C 1/0488; B01D 53/1475; C01B 3/025; C01B 3/586; B01D 2257/708; C01B 2203/068; C01B 2203/0233; C01B 2203/0445; C01B 2203/047; C01B 2203/0475; C01B 2203/048; B01D 2257/702

(57) ABSTRACT

Systems and methods for the synthesis of ammonia includes a reformer; a carbon monoxide converter; a carbon dioxide scrubber unit with recovery; a methanation unit; and an ammonia synthesis unit; wherein the carbon dioxide scrubber unit with recovery is connected to at least one fired auxiliary steam boiler.

The invention relates to a plant for ammonia synthesis, to a process for ammonia synthesis, and to the use of the plant of the invention for ammonia synthesis for producing ammonia and abating volatile hydrocarbons (VOC and HAP).

In light of the worldwide growth in population, the importance of developing flexible and efficient fertilizers is great and growing. A very large fraction of worldwide fertilizer production is accounted for by fertilizers containing urea. These water-soluble fertilizers break down in the soil into ammonium salts and/or nitrates and represent an important base fertilizer. These urea-containing fertilizers may be combined with further elements such as potassium, manganese, phosphates, sulfur, sulfur compounds, selenium and calcium.

Urea may be prepared according to the simplified equations [1] and [2]:

2NH₃+CO₂ [symbol] H₂N—COONH₄ [1]

H₂N—COONH₄ [symbol] (NH₂)₂CO+H₂O [2]

The two starting materials, ammonia and carbon dioxide, may be provided in the ammonia synthesis based on the Haber-Bosch process. Ammonia is the second most widely produced synthetic chemical in the world (Ullmann's Encyclopedia of Industrial Chemistry, 2012, Wiley-VCH Verlag GmbH & Co. KGaA, Weinheim, DOI:10.1002/14356007.o02_o11, hereinafter “Ullmann's”).

This ammonia is produced essentially from the elements hydrogen and nitrogen and an iron catalyst. The temperatures vary frequently in the range between 400° C. and 500° C. under a pressure over 100 bar. The key factor for the operating costs lies in the provision of hydrogen from synthesis gas production (Ullmann's, page 139).

Ammonia is preferably generated, accordingly, in the basic way described, for example, in Holleman, Wiberg, Lehrbuch der Anorganischen Chemie, 102 edition, 2007, pages 662-665 (ISBN 978-3-11-017770-1), based on the “Haber-Bosch process”, from the elements in accordance with equation [3]:

3H₂+N₂ [symbol] 2NH₃+92.28 kJ [3]

The reactant nitrogen (N₂) may be obtained, for example, by low-temperature air separation or by reduction of oxygen in air by combustion. The hydrogen is obtained preferably via the “steam reforming process” in accordance with equation [4]:

CₙH₂m+nH₂O [symbol] (n+m)H₂+nCO [4]

In the subsequent “carbon dioxide conversion” there is a further reaction in accordance with equation [5]:

CO+H₂O [symbol] CO₂+H₂ [5]

The carbon dioxide (CO₂) formed in accordance with equation [5] serves preferably as a carbon dioxide source for the urea synthesis in accordance with equations [1] and [2].

The present process, like many other industrial synthesis gas processes, is also associated with the formation of VOC (Volatile Organic Compounds) and HAP (Hazardous Air Pollutants) emissions. VOCs and HAPs are increasingly a problem. In the USA, for example, methanol is classed as a VOC and is therefore subject to strict emissions limits. Methanol and other VOCs and HAPs come about, for example, as byproducts of synthesis gas production in the front end, for example, of an ammonia plant. Subsequently, at various points, they pass by way of diverse circuitous routes into the environment. One possibility, for example, is the line for blowing off excess CO₂, which to date has often been subject to no cleaning at all. Methanol and other VOCs and HAPs pass by way of absorption into the scrubbing solution of the CO₂ scrub and into the CO₂ scrub circuit, where they accumulate and are emitted via the CO₂ gas. The CO₂ gas is usually not entirely consumed in downstream process plants, such as in the urea synthesis, for example. Consequently, there remains an excess CO₂ stream, loaded with methanol and other VOCs and HAPs, that is emitted without treatment into the surrounding environment.

EP 0 345 504 A1 discloses an apparatus for implementing exothermic, catalytic gas reactions for ammonia synthesis or methanol synthesis.

DE 10 2010 035 885 A1 discloses a process for producing synthesis gas from hydrocarbon-containing feedstock gases, where an autothermal reforming is carried out at a low steam/carbon ratio.

DE 10 2009 013 691 A1 discloses a process for the combined offgas treatment of ammonia-containing and nitrogen oxide-containing offgas streams in industrial plants.

EP 0 294 564 A1 discloses a process for reducing the emission of NH3.methanol from an ammonia synthesis plant, with stripping of the condensates containing dissolved ammonia and methanol.

US 2017/0320728 A1 discloses a process for reducing VOC emissions by returning the carbon dioxide waste air stream to the primary reformer of the ammonia synthesis plant.

U.S. Pat. No. 6,178,774 B1 discloses a process for producing an ammonia synthesis mixture and carbon monoxide.

U.S. Pat. No. 4,198,378 A discloses a process for removing gaseous impurities such as H₂S and CO₂. The impurities are removed in an absorption column.

DE 10 2014 209 635 A1 discloses an apparatus and a process for producing synthesis gas, using two autothermal reformers.

DE 103 34 590 A1 discloses a method for recovering hydrogen from a methane-containing gas.

EP 0 604 554 B1 discloses a process for producing a nitrogen-containing gas stream, which contains more than 21 mol % of oxygen, with a gas turbine which has an air compressor unit and an energy production unit.

US 2017/0166518 A1 discloses a process for increasing the capacity of a urea synthesis complex.

Further processes for producing ammonia are found in WO 90/06281 A1 and US 2008/0228321 A1. Processes for providing hydrogen are found in US 2017/0158504 A1, U.S. Pat. No. 3,441,393 A and WO 2010/109184 A1.

The object of the present invention is that of providing a plant for ammonia synthesis which exhibits significantly reduced emission of volatile, environmentally harmful and health-damaging hydrocarbons (VOCs and HAPs).

The object of the invention is achieved, surprisingly, by a plant for ammonia synthesis as claimed in claim 1. Further advantageous embodiments are found in the dependent claims.

The invention additionally embraces a process for ammonia synthesis. Further advantageous embodiments are found in the respective dependent claims.

The invention additionally embraces the use of the plant of the invention for ammonia synthesis for producing ammonia and abating volatile hydrocarbons (VOC and HAP).

The plant of the invention for ammonia synthesis comprises at least the components described below. Serving for the provision of hydrogen is a reformer, preferably a primary and a secondary reformer and/or an autothermal reformer. Hydrogen is formed in this case preferably, in principle, in accordance with the equation above

CₙH₂m+nH₂O [symbol] (n+m)H₂+nCO [4]

The way in which the reformer functions is set out in Ullmann's, chapter 6.1.1, pages 174 to 179. The plant of the invention further comprises a carbon monoxide (CO) converter. In this converter, the carbon monoxide (CO) formed in equation [4] and not needed for the ammonia synthesis itself is converted into carbon dioxide with further formation of hydrogen, preferably in accordance with equation [5].

CO+H₂O [symbol] CO₂+H₂ [5]

A description of the functioning and construction of possible carbon monoxide (CO) converters (“carbon monoxide shift conversion”) is found in Ullmann's, chapter 6.1.2, pages 179 to 182. The carbon monoxide (CO) converter is followed by a carbon dioxide (CO₂) scrubber unit with regeneration. The term “unit” in the sense of the invention embraces apparatus and equipment known to the skilled person for the stated purpose—in this case, typically/for example, an absorber, a desorber, one or more circulation pumps, and also heat exchangers for heating/cooling the solvent. A carbon dioxide (CO₂) scrubber unit with regeneration may be configured, for example, as a known apparatus/arrangement, in which carbon dioxide is dissolved in a suitable solvent—potassium carbonate or amines, for example—under pressure in an absorber and then separately from the rest of the synthesis gas (the synthesis gas freed from carbon dioxide or depleted in carbon dioxide in the carbon dioxide (CO₂) scrubber unit with regeneration) is expanded (“flash”). The solvent can then be reheated and regenerated in a stripping column (desorber). A detailed description is found for example in Ullmann's, chapter 6.1.3, pages 182 to 184. A carbon dioxide (CO₂) scrubber unit with regeneration differs from an adsorption process (pressure swing adsorption PSA, for example) in that the first-mentioned unit does not remove the nitrogen (N₂) component, which is essential for the subsequent ammonia synthesis, from the synthesis gas stream and possesses overall a selectivity, in the removal of gas components, that is appropriate to the intended use.

A methanization unit allows the further abatement of oxides of carbon (COₓ). This takes place, for example, in accordance with equations [6] and [7]:

CO+3H₂ [symbol] CH₄+H₂O [6]

CO₂+4H₂ [symbol] CH₄+2H₂O [7]

The methanization unit in the sense of the invention preferably comprises additional plant elements for purification, by way for example of the Selectoxo process, methanolation, dryers, cryogenic processes, scrubbing with liquid nitrogen and/or pressure swing adsorption. The term “unit” in the sense of the invention embraces apparatus and equipment known to the skilled person for the stated purpose. A detailed description is found in Ullmann's, chapter 6.1.3, pages 184 to 186. Process conditions for equations [6] and [7] are, for example, 25 bar to 35 bar and 250° C. to 350° C. over a nickel catalyst.

The plant of the invention further comprises an ammonia synthesis unit. The term “unit” in the sense of the invention embraces apparatus and equipment known to the skilled person for the stated purpose. The ammonia synthesis unit comprises the actual ammonia synthesis reactor for the reaction of hydrogen and nitrogen in accordance with equation [3]. Nitrogen may be provided preferably in an attached air separation plant or from the process air processed (i.e., “burned”) in the secondary reformer. Examples of suitable reactors are also found in EP 0 345 504 A1 and DE 35 22 308 A1, examples 1 to 7 and the description. The ammonia synthesis unit is preferably connected to apparatuses for purification, compression and/or liquefaction.

The plant of the invention is characterized in that the carbon dioxide (CO₂) scrubber unit with regeneration is connected to at least one fired auxiliary steam boiler. In the fired auxiliary steam boiler, the carbon dioxide not needed in further process steps is burned before emission to the atmosphere. The volatile hydrocarbons (VOCs and HAPs) contained in this carbon dioxide stream from the carbon dioxide (CO₂) scrubber unit with regeneration, such as methanol, for example, are therefore converted into carbon dioxide and water in the fired auxiliary steam boiler. In the sense of the invention, the expression “fired auxiliary steam boiler” preferably embraces thermally fired (heating by generation of thermal energy) elements for generating (process) steam and heat.

Connected preferably in the process direction and in series are the reformer, the carbon monoxide (CO) converter, the carbon dioxide (CO₂) scrubber unit with regeneration, the methanization unit and ammonia synthesis unit. The expression “connected” in the sense of the invention embraces suitable pipes, connectors, pumps, compressors, etc., which are suitable for the transport of liquids and gases even at subatmospheric (less than 1 bar) and superatmospheric (greater than 1 bar) pressures. Disposed between the aforesaid elements there may be further elements such as heat exchangers, pumps, compressors, heaters, etc. The carbon dioxide (CO₂) scrubber unit with regeneration has an additional connection to at least one fired auxiliary steam boiler. The fired auxiliary steam boiler is usually part of the plant processing synthesis gas. The expression “auxiliary steam boiler” in the sense of the invention preferably embraces apparatus for steam generation which provide heat/energy for steam generation by way of a combustion procedure. In principle the procedure is applicable across all chemical plants which feature methanol, VOC and HAP emissions at a comparatively small process vent and which possess a fired auxiliary steam boiler.

The fired auxiliary steam boiler is preferably connected to a waste air apparatus and therefore allows the emission of the carbon dioxide stream not utilized further, in other process steps, for example. This carbon dioxide stream is cleaned/depleted in terms of VOCs and HAPs.

In one preferred embodiment, the reformer comprises a (primary) steam reformer with or without secondary reformer, and/or an autothermal reformer. In the case of high daily ammonia production in particular, the reformer may also consist only of one or of two or more autothermal reformers.

Connected preferably in the process direction and in series are the reformer, the carbon monoxide (CO) converter, the carbon dioxide (CO₂) scrubber unit with regeneration, the methanization unit and the ammonia synthesis unit. The carbon dioxide (CO₂) scrubber unit with regeneration has an additional connection to at least one fired auxiliary steam boiler.

The fired auxiliary steam boiler preferably has supply lines for air (or an oxygen-containing gas and/or gas mixtures) and also supply lines for fuel, for example natural gas, hydrogen, synthesis gas, oxygen and/or mixtures thereof.

The supply lines for air is more preferably connected to the carbon dioxide (CO₂) scrubber unit with regeneration. This connection arrangement allows for direct premixing of the waste air from the carbon dioxide (CO₂) scrubber unit with the air supply to the fired auxiliary steam boiler. This above-described premixing allows for virtually complete burning of the VOCs and HAPs in the waste air from the carbon dioxide (CO₂) scrubber unit.

In a further preferred embodiment, the fired auxiliary steam boiler has a capacity of 10 tonnes to 200 tonnes of steam per hour.

The invention further embraces a process for ammonia synthesis, at least comprising the following steps.

In a first step, an alkane-containing (particularly methane-containing) gas is introduced into a reformer and, as described above in accordance with equation [4], a first synthesis gas mixture with hydrogen, carbon monoxide and carbon dioxide is obtained. The first synthesis gas mixture is transferred subsequently into a carbon monoxide (CO) converter. In the carbon monoxide (CO) converter, the carbon monoxide (CO) formed in equation [4] and not needed for the ammonia synthesis itself, and problematic for many catalysts, is converted into carbon dioxide with further formation of hydrogen, in accordance with equation [5], and a second synthesis gas mixture is obtained. The second synthesis gas mixture is subsequently introduced and transferred into a carbon dioxide (CO₂) scrubber unit with regeneration. The scrubber unit may be configured, for example, as an apparatus/arrangement wherein carbon dioxide is dissolved in a suitable solvent—potassium carbonate or amines, for example—under pressure in an absorber, and is subsequently expanded (“flash”) separately from the rest of the (virtually carbon dioxide-free) synthesis gas. The solvent can then, for example, be reheated and regenerated in a stripping column (desorber). Subsequently a third synthesis gas mixture (virtually free of or depleted in carbon dioxide) and a carbon dioxide (CO₂)-containing offgas are obtained. The third synthesis gas mixture is transferred into a methanization unit. The methanization unit allows for the further abatement of oxides of carbon (COₓ), in accordance with equations [6] and [7], for example. Subsequently a fourth synthesis gas mixture is obtained, and the fourth synthesis gas mixture is introduced into an ammonia synthesis unit. The ammonia synthesis unit comprises the actual ammonia synthesis reactor for the reaction of hydrogen and nitrogen preferably in accordance with equation [3]. In the ammonia synthesis unit, ammonia is obtained. This ammonia is subsequently—preferably by one or more pressure reductions—processed, compressed and/or liquefied. The continuous process of the invention is characterized in that the carbon dioxide (CO₂)-containing offgas (from the carbon dioxide (CO₂) scrubber unit with regeneration) is introduced wholly or partly into a fired auxiliary steam boiler and, by oxidation (combustion) in the auxiliary steam boiler, an offgas free of or low in volatile hydrocarbons (VOC and HAP) is obtained. Those parts of the carbon dioxide-containing offgas not introduced into the auxiliary steam boiler may be used preferably in other process steps, such as for urea synthesis, for example.

In one preferred embodiment of the process of the invention, the reformer comprises a (primary) steam reformer with or without secondary reformer, and/or an autothermal reformer. In the case of high daily ammonia production, in particular, the reformer may also consist only of one or of two or more autothermal reformers.

The resulting ammonia and a major part of the carbon dioxide (CO₂)-containing offgas are preferably reacted to give urea in a urea plant, preferably a connected urea plant. The further utilization enables effective utilization of the ammonia and, in particular, of the natural gas used preferably for generating the synthesis gas. The stated configuration also embraces the preferred direct utilization of a portion of the carbon dioxide (CO₂)-containing offgas without combustion in the auxiliary steam boiler of the invention.

With particular preference the fired auxiliary steam boiler is operated at 170° C. to 550° C. and/or 5 bar to 150 bar on the steam generation side.

The invention additionally embraces the use of the plant of the invention for ammonia synthesis for producing ammonia and at the same time abating volatile hydrocarbons (VOC and HAP).

Additionally the invention is elucidated in more detail by means of the following figures. These figures do not limit the scope of protection of the invention, instead serving only for illustrative elucidation. The figures are not to scale.

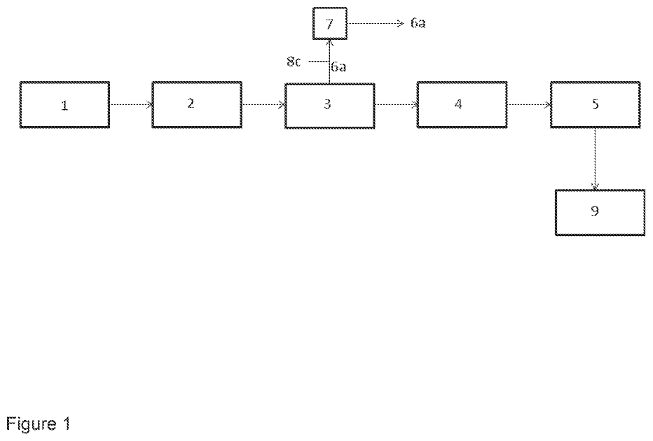

FIG. 1 shows a schematic flow diagram of a plant for ammonia synthesis, and

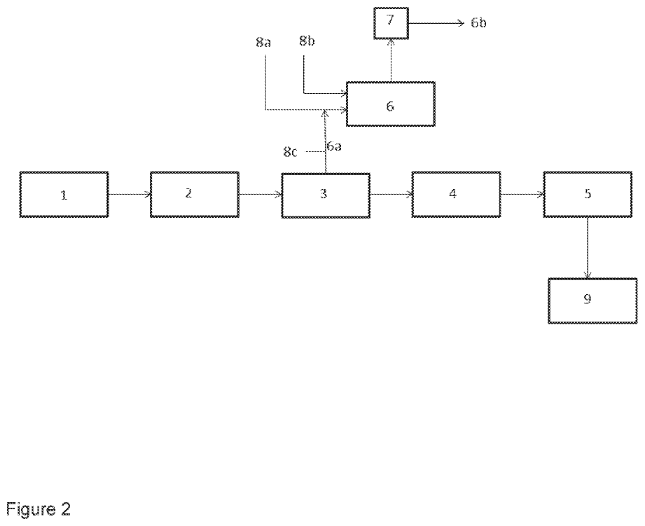

FIG. 2 shows a schematic flow diagram of a plant of the invention for ammonia synthesis.

FIG. 1 shows a schematic flow diagram of a plant for ammonia synthesis. Serving for the provision of hydrogen is a reformer (1), preferably a primary reformer and a secondary reformer and/or an autothermal reformer. Hydrogen is formed here in principle according to equation [4]. The plant additionally comprises a carbon monoxide (CO) converter (2). In this converter, the carbon monoxide (CO) formed in equation [4] and not needed in the ammonia synthesis itself is converted into carbon dioxide with further formation of hydrogen, in accordance with equation [5]. Following the carbon monoxide (CO) converter (2) there is a carbon dioxide (CO₂) scrubber unit with regeneration (3). The carbon dioxide (CO₂) scrubber unit may be configured, for example, as a known apparatus/arrangement wherein carbon dioxide is dissolved in a suitable solvent—potassium carbonate or amines, for example—under pressure in an absorber and is subsequently expanded again (“flash”) separately from the synthesis gas. The solvent can then be reheated and regenerated in a stripping column (desorber). A methanization unit (4) allows for the further abatement of oxides of carbon (COₓ). This is accomplished in accordance with equations [6] and [7], for example. The plant additionally comprises an ammonia synthesis unit (5) connected to the methanization unit (4). The ammonia synthesis unit (5) comprises the actual ammonia synthesis reactor for the reaction of hydrogen and nitrogen in accordance with equation [3]. Nitrogen may be provided preferably from the process air processed (i.e., burned) in the secondary reformer. The ammonia synthesis unit (5) is connected to apparatuses for purification, compression and/or liquefaction (9). Connected in the process direction and in series are the reformer (1), the carbon monoxide (CO) converter (2), the carbon dioxide (CO₂) scrubber unit with regeneration (3), the methanization unit (4), the ammonia synthesis unit (5), and the apparatuses for purification, compression and/or liquefaction (9). The carbon dioxide (CO₂) scrubber unit with regeneration (3) has an additional removal line (8c) for the offgases (6a) that are not required further (primarily CO₂), leading to a waste air plant (7). In the waste air plant (7), the offgases arising in the carbon dioxide (CO₂) scrubber unit (primarily CO₂) and volatile organic hydrocarbons are emitted as offgas (6a) to the surrounding environment. The expression “connected” in the sense of the invention embraces suitable pipes, connectors, pumps, compressors, etc., which are suitable for the transport of liquids and gases even at subatmospheric (less than 1 bar) and superatmospheric (greater than 1 bar) pressures. Disposed between the aforesaid elements there may be further elements such as heat exchangers, pumps, compressors, heaters, etc.

FIG. 2 shows a schematic flow diagram of the plant of the invention for ammonia synthesis. The basic construction corresponds to the construction described in FIG. 1. The plant of the invention is characterized in that the carbon dioxide (CO₂) scrubber unit with regeneration (3) is connected to a fired auxiliary steam boiler (6). The volatile hydrocarbons (VOCs and HAPs) arising in the carbon dioxide (CO₂) scrubber unit with regeneration (3), with the carbon dioxide in the carbon dioxide-containing offgases (6a), methanol for example, are burned in the fired auxiliary steam boiler and converted into carbon dioxide and water. The auxiliary steam boiler (6) is fed with air via a first supply line (8a) and with fuel gas via a second supply line (8b). The first supply line (8a) here is connected to the removal line (8c) from the scrubber unit with regeneration (3), and so the volatile hydrocarbons arising in the carbon dioxide (CO₂) scrubber unit with regeneration (3) with the CO₂ are premixed with atmospheric oxygen. Via the waste air apparatus (7), offgas (6b) free of or low in volatile hydrocarbons (VOC and HAP) passes into the atmosphere.

### LIST OF REFERENCE SYMBOLS

(1) Reformer
(2) Carbon monoxide (CO) converter
(3) Carbon dioxide (CO₂) scrubber unit with regeneration
(4) Methanization unit
(5) Ammonia synthesis unit
(6) Fired auxiliary steam boiler
(6a) The carbon dioxide (CO₂)-containing offgas
(6b) Offgas free of or low in volatile hydrocarbons (VOC and HAP)
(7) Waste air plant
(8a) First supply line
(8b) Second supply line
(9) Apparatuses for purification, compression and/or liquefaction

1.-14. (canceled)

15. A plant for ammonia synthesis, at least comprising:
a reformer;
a carbon monoxide converter;
a carbon dioxide scrubber unit with regeneration;
a methanization unit; and
an ammonia synthesis unit;
wherein the carbon dioxide scrubber unit with regeneration is connected to at least one fired auxiliary steam boiler.

16. The plant of claim 15 wherein the fired auxiliary steam boiler is connected to a waste air apparatus.

17. The plant of claim 15 wherein the reformer comprises a steam reformer with or without secondary reformer, and/or an autothermal reformer.

18. The plant of claim 15 wherein an air separation plant is included and/or the nitrogen is provided from the process air treated in a secondary reformer.

19. The plant of claim 15 wherein connected in the process direction and in series are the reformer, the carbon monoxide converter, the carbon dioxide scrubber unit with regeneration, the methanization unit and ammonia synthesis unit, and the carbon dioxide scrubber unit with regeneration has an additional connection to at least one fired auxiliary steam boiler.

20. The plant of claim 15 wherein the fired auxiliary steam boiler has supply lines for air and supply lines for fuel.

21. The plant of claim 20 wherein the supply lines for air are connected to the carbon dioxide scrubber unit with regeneration.

22. The plant of claim 15 wherein the fired auxiliary steam boiler has a capacity of 10 tonnes to 200 tonnes of steam per hour.

23. A process for ammonia synthesis, comprising:
introducing an alkane-containing gas into a reformer and obtaining a first synthesis gas mixture;
introducing the first synthesis gas mixture into a carbon monoxide converter and obtaining a second synthesis gas mixture;
introducing the second synthesis gas mixture into a carbon dioxide scrubber unit with regeneration and obtaining a third synthesis gas mixture and an offgas containing carbon dioxide;
introducing the third synthesis gas mixture into a methanization unit and obtaining a fourth synthesis gas mixture;
introducing the fourth synthesis gas mixture into an ammonia synthesis unit and obtaining ammonia;
wherein the offgas containing carbon dioxide from said introducing the second synthesis gas mixture is introduced wholly or partly into a fired auxiliary steam boiler, and, by oxidation in the auxiliary steam boiler, obtaining an offgas free of or low in volatile hydrocarbons.

24. The process of claim 23 wherein the reformer comprises a steam reformer with or without secondary reformer, and/or an autothermal reformer.

25. The process of claim 23 wherein the ammonia and a major part of the offgas containing carbon dioxide or offgas free of or low in volatile hydrocarbons are reacted in a urea plant to form urea.

26. The process of claim 23 wherein the fired auxiliary steam boiler is operated at 170° C. to 550° C. on a steam generation side.

27. The process of claim 23 wherein the fired auxiliary steam boiler is operated at 5 bar to 150 bar on the steam generation side.
